(19) United States
(12) Patent Application Publication
(10) Pub. No.: US 2009/0148563 A1
(43) Pub. Date: Jun. 11, 2009

(54) Gum Arabic Binding System for Savory Crunchy Granola Bars

(75) Inventors: John Schuette, Woodstock, IL (US); Sonali Shirke, Mount Prospect, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Quaker Oats Company, Chicago, IL (US)

(21) Appl. No.: 11/951,534

(22) Filed: Dec. 6, 2007

(51) Int. Cl. A23L 1/05; A23L 1/30

(52) U.S. Cl. 426/72; 426/578

(57) ABSTRACT

A savory food binder composition comprising: between about 25 to about 50% by weight of moisture content, between about 15 to about 25% by weight of a fat, between about 20 to about 30% by weight of a food hydrocolloid, and between about 10 to about 30% by weight of a non-hydrocolloid carbohydrate. The savory food binder composition can be used in the preparation and manufacture of savory crunchy granola-type bars.

### FIELD OF THE INVENTION

The present invention relates to a savory food binder composition that can be used in the manufacture of savory, crunchy granola-type bars and methods of producing such savory, crunchy granola-type bars.

### BACKGROUND OF THE INVENTION

Food binders are generally a mixture of carbohydrates, fats, water, as well as a variety of other minute components such as antioxidants, emulsifiers, salts, vitamins and flavors. Food binders are usually heated and mechanically treated, such as mixing together the components of the binder. The desired result of these treatments is a food with a pleasant taste and texture. For this reason, food products with improved flavor, texture, quality and even health benefits are desirable and in demand.

A variety of components have been used as food binders to bind food materials in various methods in order to shape the final food product. The predominant use of food binders is in confectionery and baking industries which use food binders in a variety of ways. Many such binders are for sweet confectioneries and are/or sugar based which limits them to food products with a sweet taste. The ability of these binders to modify the texture of the final food product depends on the solid content and the sugar type. In addition, the moisture content of food products is an important factor in connection with the shelf-life of the final food product. Food binders with a low solid content and high moisture content may have an unappetizing texture and a limited shelf-life.

### BRIEF SUMMARY OF THE INVENTION

The present invention relates to a savory food binder composition that can be advantageously used in the production of a savory crunchy granola bar.

According to one aspect, the present invention provides a savory food binder composition comprising: (i) between about 25 to about 50% by weight of moisture content, (ii) between about 15 to about 25% by weight of a fat, (iii) between about 20 to about 30% by weight of a food hydrocolloid, and (iv) between about 10 to about 30% by weight of a non-hydrocolloid carbohydrate.

According to another aspect, the present invention provides a food product comprising: (i) between about 55 to 80% by weight of a dry food component, (ii) between about 20 to 45% by weight of a savory food binder composition, as described herein and (iii) less than about 5% by weight of a flavoring.

According to another aspect, the present invention provides a method of aggregating dry food components to create a savory, crunchy, granola-type bar food product, the method comprising combining a savory food binder composition, as described herein, with dry food components.

### DETAILED DESCRIPTION OF THE INVENTION

The present invention now will be described more fully hereinafter, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all terms of art, notations and other scientific terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art, such as, for example, as widely utilized in food industries.

In accordance with an embodiment of the present invention, there is provided a new savory food binder composition that allows the binding of dry food components with different flavorings. As used herein, the term “savory” is intended to mean a food binder composition with a low sugar content, preferably less than 10% by weight of sugar.

As used herein, the term “binder” or “binding system” is intended to mean a composition that produces or promotes cohesion in dry ingredients. Because the binder described herein is intended to be used in the production of a food product, it is preferably a food-grade binder. In an embodiment, the food binder composition described herein is a savory binder with a low glycemic index.

According to one embodiment, the savory food binder composition comprises between about 25 to about 50% by weight of moisture content. The moisture content of the savory food binder composition may be calculated during formulation by knowing and mathematically totaling the moisture content of each ingredient.

In an embodiment, water can be used in the production of the savory food binder composition to provide the necessary moisture content. Those skilled in the art will recognize that the water can be replaced by any other food-grade aqueous solutions.

According to another embodiment, the savory food binder composition comprises between about 15 to about 25% by weight of a fat. In one embodiment, the fat present in the savory food binder composition is in the form of a oil, a saturated fat and/or an unsaturated fat, or combinations thereof. The fat used is preferably a oil, such as corn oil.

In a further embodiment, the savory food binder composition comprises between about 20 to about 30% by weight of a food hydrocolloid. As used herein, the term “hydrocolloid” is intended to mean a hydrophilic polymer containing many hydroxyl groups and may be a polyelectrolyte. Gum Arabic can be a preferred hydrocolloid because of its very high water solubility, and its low viscosity in comparison to other hydrocolloids. Gum Arabic can also be relatively inexpensive in comparison to some other hydrocolloids. In addition, Gum Arabic is a good fiber source and is sugar-free. The hydrocolloid content of a composition can be calculated by those skilled in the art during formulation.

In another embodiment, the savory food binder composition comprises between about 10 to about 30% by weight of a non-hydrocolloid carbohydrate. As used herein, the term “non-hydrocolloid carbohydrate” refers to carbohydrates other than the hydrocolloids described above. The non-hydrocolloid carbohydrate can be selected from the group consisting of corn syrup, inulin and maltodextrin or a mixture thereof. Because the savory food binder composition is used in the production of savory food products, the presence of the non-hydrocolloid carbohydrate in the savory food binder composition does not give a sweet taste to the binder due to the low sweetness of the carbohydrates. The non-hydrocolloid carbohydrate used in the savory food binder composition may be in a solid or a liquid form. Optionally, the non-hydrocolloid carbohydrate may be in the form of a syrup or a solid.

In yet another embodiment, the savory food binder composition may also comprise less than about 5% by weight of an emulsifier and an antioxidant. As used herein, an emulsifier is intended to mean a surface-active agent promoting the formation and stabilization of the emulsion. Such emulsifiers include, but are not limited to, lecithins. As used herein, an antioxidant is intended to mean molecules that slow or prevent oxidation. Such antioxidants include, but are not limited to, tocopherols. The addition of an emulsifier can facilitate the processing of the savory food binder composition and food products containing the binder by preventing separation of the aqueous phase and the lipid phase. The addition of an antioxidant can help to prevent oxidation of lipid components during processing and during shelf-life.

In a further embodiment, the savory food binder composition comprises between about 20% and 45% of total weight of a food composition. As used herein, the term “total weight of a food composition” refers to the sum of the dry ingredients, syrup ingredients and flavors of the final food product. The total weight of a food composition can be easily determined by those skilled in the art.

The savory food binder composition may further comprise salts, such as but not limited to sodium chloride and sodium bicarbonate.

The savory food binder composition described herein can be used with various food products, such as granola-type bars. The savory food binder composition described herein can be incorporated in any food production to allow the cohesion of the ingredients and facilitate the shaping of the final food product. The food product may comprise between about 55 to about 80% by weight of dry food components, between about 20 to about 45% by weight of a savory food binder composition, as described herein, and less to about 5% by weight of a flavoring. In addition, because the savory food binder composition does not have a sweet taste, it can be advantageously used in the preparation of a savory food. The savory food binder composition is particularly useful in binding the dry food components of the granola-type bars (such as rolled oats, crisp rice, sugars, nuts and a vitamin premix).

The savory food binder composition presented herein can have little or no perceptible effect on the taste or flavor of the final food product and/or will not introduce perceptible undesirable tastes, flavor or sweetness.

In a further embodiment, the final food product may also comprise between about 5 to about 10% by weight of a protein. Such protein sources include, but are not limited to, soy proteins, milk proteins, egg proteins, and pea proteins.

In yet another embodiment, the final food product may be a high fiber bar and comprise between about 2 to about 25% by weight of a fiber. Such fiber sources include, but are not limited to, Gum Arabic.

In still another embodiment, the final food product may be a low glycemic index savory bar and comprise between about 5 to about 10% by weight of a sugar. As the savory food binder composition comprises between about 20 to about 30% by weight of a food hydrocolloid, preferably Gum Arabic, the sugar-free contents of Gum Arabic can be advantageously used for the preparation of a low glycemic index savory bar.

In a further embodiment, the final food product is between about 55% and about 80% of total solids and between about 20% and about 45% of total syrups. As used herein, the term “total solids” refers to the sum of dissolved and suspended solid constituents. Its percentage can be easily calculated by subtracting the moisture content of the composition from the value 100. The total solid content can be readily determined by those skilled in the art. As used herein, the term “total syrups” refers to the liquid content of the final food composition. The total syrup content of the final food composition can be readily calculated during formulation by knowing and adding the liquid content of each ingredient.

The final food product, after addition of the savory food binder composition, will not be disintegrated upon refrigeration or thawing, so that the binding of the final food composition is maintained.

Although savory crunchy granola bars are preferably targeted for the use of the savory food binder composition, any other shape such as a bite size, a square, or an irregular shape food product which is normally made with the incorporation of a food binder, can be considered among the different embodiments or variants of the present invention. The concentration of the savory food binder composition can be adapted depending on its use or the final food product in which it is incorporated.

In another embodiment, the present application provides a method of using the savory food binder composition described herein. In order to combine the savory food binder composition to the dry food components, first, the blended dry syrup ingredients are slowly added to ambient temperature water and mixed thoroughly. Second, the oil and emulsifier are added and blended. Third, flavors can then be blended with the savory food binder composition. Fourth, dry food components (rolled oats, crisp rice, sugar, nuts and vitamin premix) can then be added to the savory food binder composition to form a wet granola mixture. A gentle but thorough mixing of the dry food components to the savory food binder composition preserves the integrity of the finished food product. Lastly, the wet granola mixture can be sheeted to form a slab or can be pressed into molds to form a slab and/or other shapes. The wet granola mixture can then be baked to create the final food product of savory crunchy granola bars.

The present invention will be more readily understood by referring to the following examples which are given to illustrate the invention rather than to limit its scope.

### EXAMPLES

### Example 1

### Savory Food Binder Composition with Gum Arabic and Corn Syrup Solids

Each amount identified below is in percentage of final weight of the ingredients used in the preparation of savory food binder compositions.

| Ingredients | Amount (Wt. %) |
|---|---|
| Corn Syrup Solids | 15.260 |
| Gum Arabic | 30.000 |
| Water | 28.054 |
| Tocopherols | 0.126 |
| Lecithin | 1.729 |
| Corn Oil | 21.451 |
| Salt | 3.000 |
| Sodium bicarbonate | 0.378 |

The corn syrup solids can be replaced or mixed with other non-hydrocolloid carbohydrates, such as inulin or maltodextrin, at around the same level.

### Example 2

### Savory Crunchy Granola Bar

The amount is in percentage of final weight of the ingredients used in the preparations of the dry components, the savory food binders and flavorings.

| | Dry Components (73% | Savory Food Binder | Flavorings (2% of total |
|---|---|---|---|
| | of total weight of final | (25% of total weight of | weight of final food |
| Ingredients | food product) | final food product) | product) |
| Rolled Oats | 62.856 | | |
| Crisp Rice | 25.430 | | |
| Sugar | 8.000 | | |
| Corn Oil | 3.502 | | |
| Vitamin Premix | 0.210 | | |
| Corn Syrup Solids | | 15.260 | |
| Gum Arabic | | 30.000 | |
| Water | | 28.054 | |
| Tocopherols | | 0.126 | |
| Lecithin | | 1.729 | |
| Corn Oil | | 21.451 | |
| Salt | | 3.000 | |
| Sodium bicarbonate | | 0.378 | |
| Flavor | | | 100.000 |

The corn syrup solids can be replaced or mixed with other non-hydrocolloid carbohydrates, such as inulin or maltodextrin, at around the same level.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A savory food binder composition comprising:
between about 25 to about 50% by weight of moisture content,
between about 15 to about 25% by weight of a fat,
between about 20 to about 30% by weight of a food hydrocolloid, and
between about 10 to about 30% by weight of a non-hydrocolloid carbohydrate.

2. The savory food binder composition of claim 1, wherein said fat is in a form selected from the group consisting of an oil, a saturated fat and an unsaturated fat.

3. The savory food binder composition of claim 2, wherein said oil is corn oil.

4. The savory food binder composition of claim 1, wherein said hydrocolloid is Gum Arabic.

5. The savory food binder composition of claim 1, wherein said non-hydrocolloid carbohydrate is selected from the group consisting of a corn syrup, an inulin and a maltodextrin or combinations thereof.

6. The savory food binder composition of claim 5, wherein said non-hydrocolloid carbohydrate is either a syrup or solid or combinations thereof.

7. The savory food binder composition of claim 1, further comprising less than about 5% by weight of an emulsifier and an antioxidant.

8. The savory food binder composition of claim 1, having between about 20% and about 45% of total weight of a food composition.

9. A savory food product comprising the savory food binder composition of claim 1.

10. A food product comprising:
between about 55 to about 80% by weight of a dry food component,
between about 20 to about 45% by weight of a savory food binder composition,
less to about 5% by weight of a flavoring, and said savory food binder composition comprising:
between about 25 to about 50% by weight of moisture content,
between about 15 to about 25% by weight of a fat,
between about 20 to about 30% by weight of a food hydrocolloid, and
between about 10 to about 30% by weight of a non-hydrocolloid carbohydrate.

11. The food product of claim 10, wherein said dry food component is selected from the group consisting of a rolled oat, a crisp rice, a sugar, a nut and a vitamin premix and combinations thereof.

12. The food product of claim 10 being a savory food.

13. The food product of claim 10 being a granola-type bar.

14. The food product of claim 10 being a crunchy-type bar.

15. The food product of claim 10, further comprising between about 5 to about 10% by weight of a protein.

16. The food product of claim 10 being a high fiber bar comprising between about 2 to about 25% by weight of a fiber.

17. The food product of claim 10 being a low glycemic index savory bar comprising between about 5 to about 10% by weight of a sugar.

18. The food product of claim 10, having between about 55% and about 80% of total solids and between about 20% and about 45% of total syrups.

19. The food product of claim 10, wherein said food product has a shape selected from the group consisting of a bar, a bite size, a square and an irregular shape.

20. A method of aggregating dry food components to create a savory, crunchy, granola-type bar food product, said method comprising combining a savory food binder composition with said dry food components, said savory food binder composition comprising:
between about 25 to about 50% by weight of moisture content, between about 15 to about 25% by weight of a fat, between about 20 to about 30% by weight of a food hydrocolloid, and between about 10 to about 30% by weight of a non-hydrocolloid carbohydrate.

21. The method of claim 20, wherein said savory food binder composition is heated to around 130 to around 140° F. prior to its combination with said dry food components.

22. The method of claim 20, wherein a flavoring is blended with said savory food binder composition.

23. The method of claim 20, wherein said dry food components is combined to said savory food binder composition to create a wet granola mixture.

24. The method of claim 23, wherein said wet granola mixture is baked to create a savory, crunchy granola bar.
